(19) United States
(12) Patent Application Publication
(10) Pub. No.: US 2006/0253524 A1
(43) Pub. Date: Nov. 9, 2006

(54) Representations of conversational policies

(76) Inventors: Paul Evan Foreman, Austin, TX (US); David Perry Greene, Austin, TX (US); Philip Edward Light, Austin, TX (US); Razvan Loghin, Austin, TX (US); Anand Srinivasan, Arlington Heights, IL (US)

Correspondence Address: IBM CORP (YA);C/O YEE & ASSOCIATES PC, P.O. BOX 802333, DALLAS, TX, 75380, US

(21) Appl. No.: 11/122,947

(22) Filed: May 5, 2005

(51) Int. Cl. G06F 15/16

(52) U.S. Cl. 709/200

(57) ABSTRACT

A method and apparatus for creating new representations of a conversational policy or conversation are shown. The conversational policy or a specific conversation can be displayed in a tabular form, which emphasizes order and timing. Representing the policy as a ‘filmstrip’ or series of interactions can make writing the conversational policy more understandable.

### CROSS REFERENCE TO RELATED APPLICATIONS

The present application is related to copending U.S. patent application Ser. No. ______ (IBM Docket No. AUS920040543US1 entitled “Method and Apparatus for Creation of an Interface for Constructing Conversational Policies”) filed even date herewith. The above mentioned patent application is assigned to the assignee of and shares the same inventors as the present invention. The content of the cross referenced copending applications are hereby incorporated herein by reference.

### BACKGROUND OF THE INVENTION

1. Technical Field

The present invention is generally directed to policies that govern conversations between two or more network computer systems or persons responding through the network computer systems. Even more specifically, the present invention is directed to an apparatus and method for representing conversation policies in different modes, depending on the use being made of them.

2. Description of Related Art

In interactions carried out through an electronic business system, whether the entities interacting are persons or automated applications, agents or programs in the systems carry out the interaction by sending messages to each other. These interactions can be brief, such as a simple query and response, or they can be extended, such as in the negotiation of a sale of products or services, where significant information, offers, and counter-offers can be exchanged. U.S. Patent Application 20030204405, published Oct. 30, 2003, which is owned by the assignee of the current application and is hereby incorporated by reference, discloses a means for providing modular conversation policies. The modularity provides a structure in which policies can be brought in from an outside source and modified to meet a specific business system.

As the use of such conversational policies becomes more common, it becomes increasingly desirable to be able to understand conversational policies quickly and easily in order to write new policies or modify old ones. While policies are currently created in a form of extensible markup language (XML), this tag-based language does not provide an easy way to work with and understand policies. Conversational policies are generally represented as graphical flows, depicting the choices that can be made in each portion of the policy. However, these representations have proved limiting for analysis and interpretation of individual conversations within a policy and thus limit the ease with which the policy can be studied and improved.

### SUMMARY OF THE INVENTION

The present invention provides a method and apparatus that can change the representation of a conversational policy to fit the immediate action being performed on the policy. The policy can be represented not only as an XML or other extended markup language file; it can also be shown in a tabular form or as a ‘filmstrip’ or series of interactions of the information that must be gained during the conversation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a network of data processing systems in which the present invention may be implemented.

FIG. 2 depicts a block diagram of a data processing system that may be implemented as a server in which the present invention may be implemented.

FIG. 3 depicts a conversational policy shown in a graphical form, according to an exemplary embodiment of the invention.

FIG. 4 depicts a portion of a conversation that was executed under the conversational policy of FIG. 3, shown in a tabular format, according to an exemplary embodiment of the invention.

FIG. 5 depicts a conversational policy in the process of being written and which currently exists in a ‘filmstrip’ format, according to an exemplary embodiment of the invention.

FIG. 6A discloses the creation of a tabular view from a conversation, according to an exemplary embodiment of the invention.

FIG. 6B discloses the creation of a filmstrip format, according to an exemplary embodiment of the invention.

FIG. 7 depicts a flowchart for converting an extensible markup language format to a filmstrip format, according to an exemplary embodiment of the invention.

FIG. 8 demonstrates a flowchart for converting a tabular format to an XML file, according to an exemplary embodiment of the invention.

### DETAILED DESCRIPTION OF THE PREFERRED EMBODIMENT

Hardware

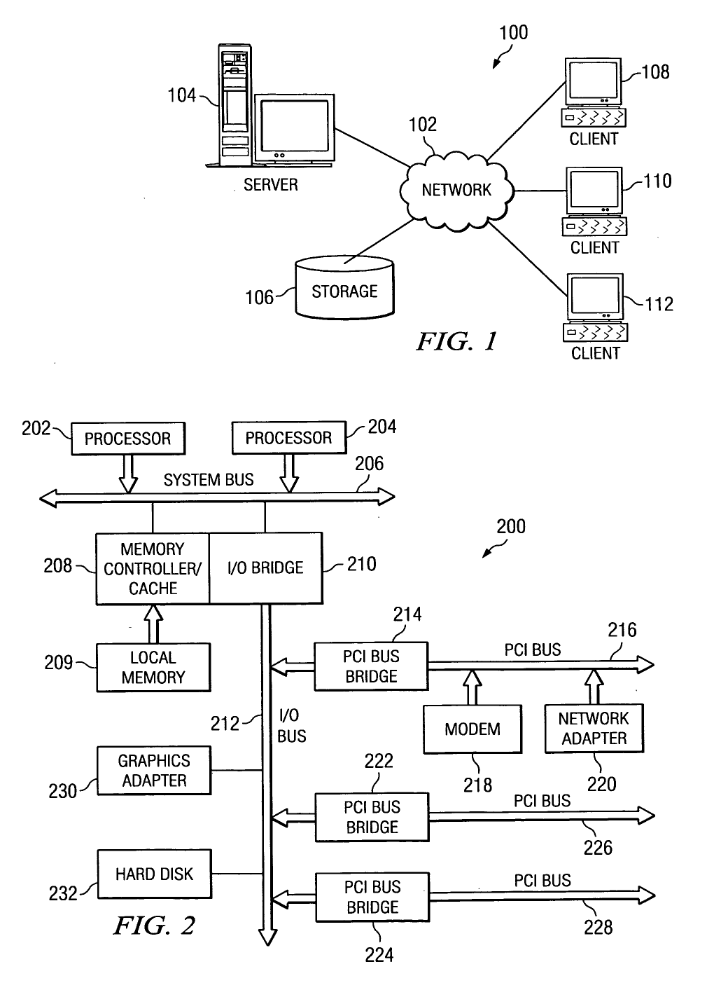

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, New York, running the Advanced Interactive Executive (AIX) operating system or LINUX operating system.

Representations of Conversational Policies

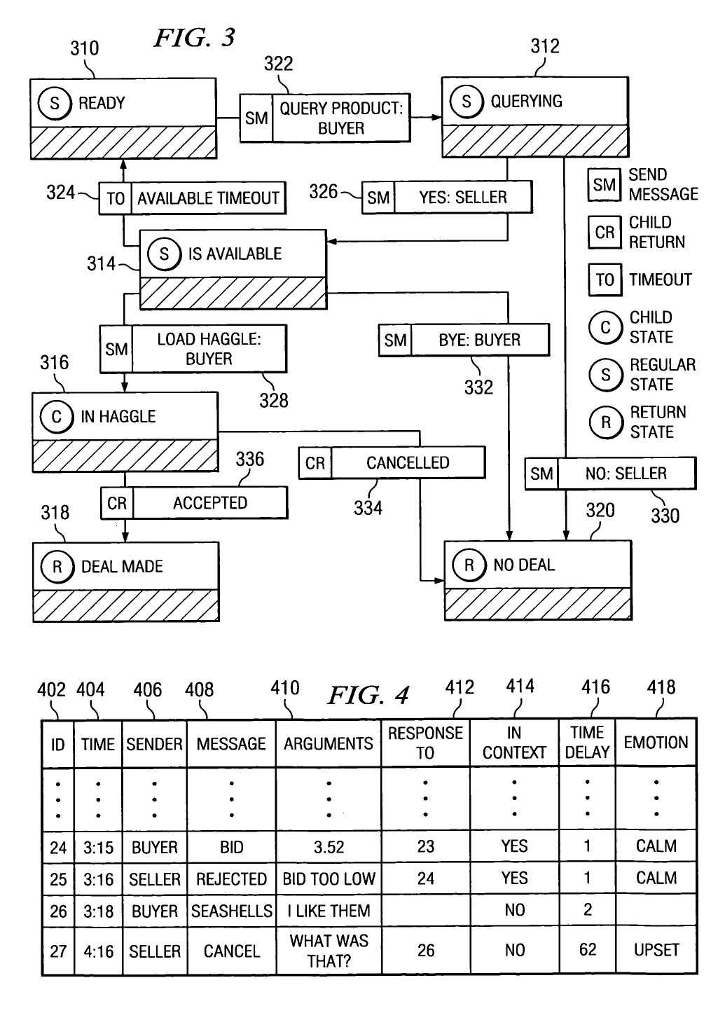

With reference now to FIG. 3, a visual diagram of an exemplary conversational policy is depicted. In this example, the conversation is between a buyer and a seller with regard to the availability and purchase of a product or service. Such conversations between machines are inherently stateful, i.e. the content of any previous messages constrains or partially determines both the content of possible messages following and the participant who is expected to make the next response. In the convention used by this figure, a state in the policy is shown by a rectangle, the lower half of which is hatched, while the upper half contains the name of the state and a circled letter indicating the type of state: a regular state contains an S in the circle, a child state contains a C, and a response state contains an R. As the name implies, a child state can be a separate conversation policy that is called by the current policy, which will return a response chosen from a set of allowable responses. The types of actions that are used to move between states are: sending a message SM, giving a response from a child state CR, or incurring a timeout TO.

The conversation policy begins with Ready State 310. There is only one way to move out of Ready State 310, i.e., the buyer will send message 322 querying the availability of an item or service. When a message of this type is sent and received, the conversation moves to the Querying State 312. While in the Querying State 312, the seller is checking to see if the requested item or service can be supplied. The response will be to provide one of two replies: ‘yes’ or ‘no’. If the product is not available, the seller sends ‘No’ message 330, which moves the conversation to ‘No Deal’ state 320, which completes this conversation. It is, of course, possible to start another conversation by querying the availability of another product, but the original conversation has reached a conclusion. Alternatively, if the item is available, sending ‘Yes’ message 326 moves the conversation to ‘Is Available’ state 314. According to the conversation policy shown, three responses are available and thus, three routes exist out of this state. In the first response, the buyer only wanted information at this time, so they send ‘Bye’ message 332, which moves the conversation to ‘No Deal’ state 320. In a second response, the buyer shows interest in pursuing the transaction, sending ‘Load Haggle’ message 328, which moves the conversation to ‘In Haggle’ state 316, which is a child state. A final way to leave ‘Is Available’ state 314 is for the buyer to give no response, so that the transaction incurs timeout 324 and returns to Ready state 310. For conversations that have reached ‘In Haggle’ state 316, this state will be maintained until either an agreement is reached between the two parties or else one party determines that a mutually satisfactory conclusion cannot be reached. If In Haggle state 316 ends with a response of ‘Accepted’ 336, the conversation moves to ‘Deal Made’ state 318 and concludes. Otherwise, ‘Cancelled’ response 334 is sent and the conversation moves to ‘No Deal’ state 320 and concludes.

The following listing is an XML file that contains the same information as the conversation policy of FIG. 3. In the appropriate setting, such a file can guide and organize the flow of a conversation between a person and a machine or even between two machines.

```
<ConversationPolicy xmlns:xsi=“http://www.w3.org/2001/XMLSchema-instance”
    xsi:noNamespaceSchemaLocation=“ConversationPolicy2.0.xsd”>
  <Name>BuyStuff</Name>
  <Roles>
    <Role>Buyer</Role>
  </Roles>
  <Roles>
    <Role>Seller</Role>
  </Roles>
  <InitialState>
    <IniStateName>Ready</IniStateName>
  </InitialState>
  <State StateId=“Ready”>
    <SendMessageTransition TransitionName=“QueryProduct”>
      <Target>Querying</Target>
      <Sender>Buyer</Sender>
      <Event>SendMessage</Event>
      <Message>
        <Encoding>java</Encoding>
      <Schema>com.ibm.conversation.BuySellCA.ProductQueryMessageSchema</Schema>
      </Message>
    </SendMessageTransition>
  </State>
  <State StateId=“Querying”>
    <SendMessageTransition TransitionName=“No”>
      <Target>NoDeal</Target>
      <Sender>Seller</Sender>
      <Event>SendMessage</Event>
      <Message>
        <Encoding>java</Encoding>
        <Schema>com.ibm.conversation.-BuySellCA.NoMessageSchema</Schema>
      </Message>
    </SendMessageTransition>
    <SendMessageTransition TransitionName=“Yes”>
      <Target>IsAvailable</Target>
      <Sender>Seller</Sender>
      <Event>SendMessage</Event>
      <Message>
        <Encoding>java</Encoding>
        <Schema>com.ibm.conversation.BuySellCA.YesMessageSchema</Schema>
      </Message>
    </SendMessageTransition>
  </State>
  <State StateId=“IsAvailable”>
    <Timeout>P5M</Timeout>
    <TimeoutTransition TransitionName=“AvailableTimout”>
      <Target>Ready</Target>
      <Event>OnTimeout</Event>
    </TimeoutTransition>
    <SendMessageTransition TransitionName=“LoadHaggle”>
      <Target>InHaggle</Target>
      <Sender>Buyer</Sender>
      <Event>SendMessage</Event>
      <Message>
        <Encoding>java</Encoding>
        <Schema>com.ibm.conversation.BuySellCA.LoadHaggleMessageSchema</Schema>
      </Message>
    </SendMessageTransition>
    <SendMessageTransition TransitionName=“Bye”>
      <Target>NoDeal</Target>
      <Sender>Buyer</Sender>
      <Event>SendMessage</Event>
      <Message>
        <Encoding>java</Encoding>
        <Schema>com.ibm.conversation.BuySellCA.ByeMessageSchema</Schema>
      </Message>
    </SendMessageTransition>
  </State>
  <State StateId=“InHaggle”>
    <LoadChild>
      <Policy>buysellhaggle.cpxml</Policy>
      <Rolemap>
        <RolemapElement>
          <Parent>Buyer</Parent>
          <Child>Initiator</Child>
        </RolemapElement>
      <RolemapElement>
          <Parent>Seller</Parent>
          <Child>Responder</Child>
        </RolemapElement>
      </Rolemap>
    </LoadChild>
    <ChildReturnTransition TransitionName=“Accepted”>
      <Target>DealMade</Target>
      <Event>ChildReturn</Event>
      <ChildReturn>Accepted</ChildReturn>
    </ChildReturnTransition>
    <ChildReturnTransition TransitionName=“Cancelled”>
      <Target>NoDeal</Target>
      <Event>ChildReturn</Event>
      <ChildReturn>Cancelled</ChildReturn>
    </ChildReturnTransition>
  </State>
  <State StateId=“NoDeal”>
    <Return>NoDeal</Return>
  </State>
  <State StateId=“DealMade”>
    <Return>DealMade</Return>
  </State>
</ConversationPolicy>
```

Co-pending application (attorney docket AUS920040543US1, filed ______) discloses a method of converting a conversation policy back and forth from a visual representation such as that shown in FIG. 3 and an XML file as shown above. The present application discloses two other representations that can be used to show a conversation policy or actual conversation and a method of converting between the formats.

Tabular View

Once a conversational policy is in effect, one can record actual conversations. These conversations can then be analyzed to discover which portions of the policy are used most heavily and whether there are parts of the policy that need to be improved. However, while the format of FIG. 3 is helpful in being able to follow the possible courses of action available in the conversation, this format is awkward when following an existing conversation, especially when steps such as bidding can be repeated. In order to study these conversations, it is necessary to place them in a format that can be tracked more easily. The tabular format, an exemplary form of which is shown in FIG. 4, has shown itself well adapted to viewing actual conversations, although it can also be used with the conversation policies themselves. In tabular view 400, each action in the conversation is saved as a row containing at least a unique identification number (ID) 402, the sender of the message 406, and the message 408. In this example of an actual conversation, the row also contains the time that the message was sent 404, the arguments of the message 410, e.g., its value, the ID of the step this action is responding to 412, whether the response is in context of the policy 414, the time delay since the last message 416, and the emotion of the sender 418. Of course, column 418, which shows emotion, would not be useful in a machine-to-machine conversation, but could be very helpful in a person-to-machine or person-to-person conversation that is structured according to a conversation policy. If one were placing a conversation policy into tabular format, one might also want to include the prior state, from which a message is sent, and the succeeding state, to which the message takes the conversation.

The columns that contain time 404, sender 406, message 408, and arguments 410 are populated with data that is immediately available in the conversation, as recorded by the controlling program. The remaining columns contain additional metadata that give added meaning to the data in the first set of columns. These columns can be populated by hand or by an automated system. For example, the emotion field can be inferred from voice tones, if the message is verbal, or from the wording, if written. A person could listen to the conversation and add the metadata for emotion. The example in FIG. 4 is not directly shown by the prior conversation policy, but can be a part of the actions that take place in the child state called ‘InHaggle’.

One of the strengths of the tabular format is that it is able to reveal information that is not available in any other format. For example, in the message with an ID of 26, the message ‘Seashells’ was not expected and not interpretable by the buyer. Therefore, the ‘In context’ column is marked to indicate that this occurred without a context in the conversation. This information is not easily displayed in any other format.

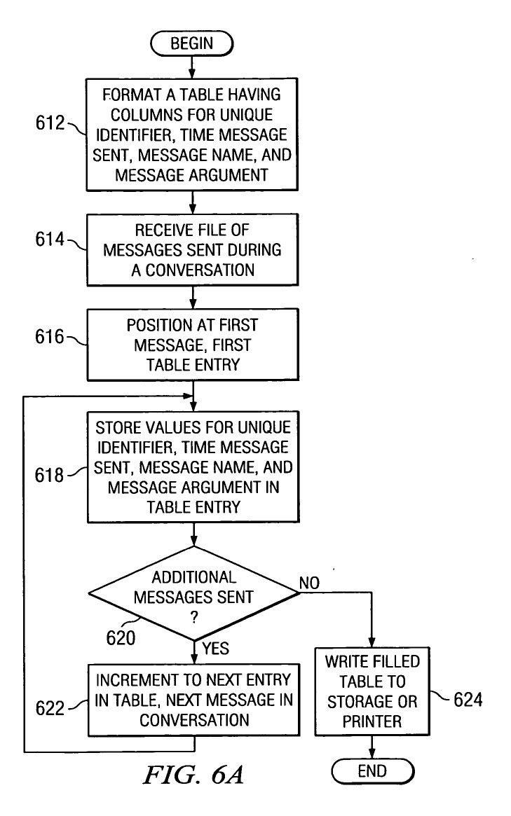

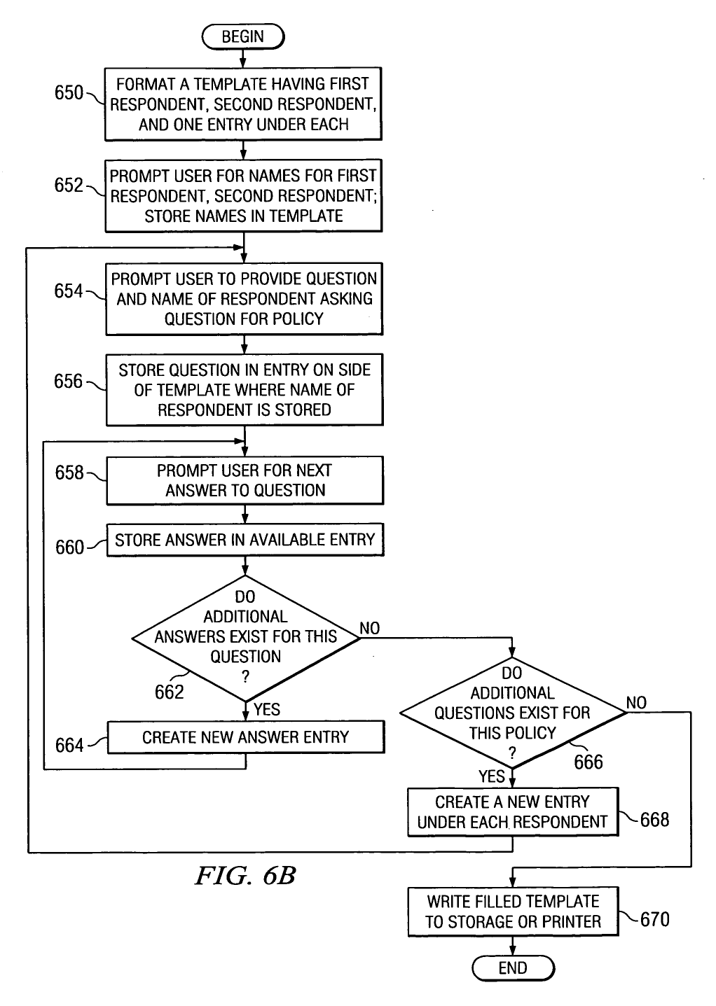

The creation of the tabular view from a conversation will now be discussed with respect to FIG. 6A. The method begins with formatting a table having columns for a unique identifier for each message, the time the message was sent, the message name, and a message argument (step 612). These are all essential items of information that are directly available from the message. Additional columns for other information can also be formatted, according to the user's need, such as the fields discussed above. If the number of messages in the file is known, the number of rows in the table can also be set; otherwise rows can be added as needed. The program that creates the tabular format is then ready to receive a file of messages sent during a given conversation (step 614). The assumption is made here that the messages are in order by the time they were sent. If this is not true, the file can be sorted by time prior to feeding into the program. The program sets pointers to the first message in the file and the first table entry (step 616). For the current message, the values for the time the message is sent, the message name, and the message argument are taken from the message and stored in the current entry of the table (step 618). The unique identifier is a number assigned by the program, generally by maintaining a counter which is incremented as a new message is used, so that the unique identifier is simply a count of the records, although other identifiers can also be used. The determination whether there are additional messages in the file is then made (step 620). If further messages remain, the program increments to the next entry in the table (adding rows if necessary) and points to the next message in the conversation (step 622), then returns to step 618 for further processing. If no further messages remain, the program is finished; it can write the filled table to either storage or to a printer (step 624), then it exits.

When making a tabular format of a conversation policy, the steps are similar, although not identical. In step 614, the process would receive a file in a version of XML, for example; step 616 would then position at the first transition definition and step 618 would store values in the table for prior step, succeeding step, and message name, as well as any other desired fields. Rather than checking for additional messages in step 620, the process would check for additional transitions and step 622 would increment to the next transition in the file.

Filmstrip View

Although the tabular format is easy to use when analyzing conversations that have taken place, it is much less useful when trying to create conversation policies from scratch, as it is difficult to see the relationship between one message and another when looking at a table that is row and column based. It can also be difficult for a person who is new to writing conversational policies to start with a view of the specific flow, as in FIG. 3.

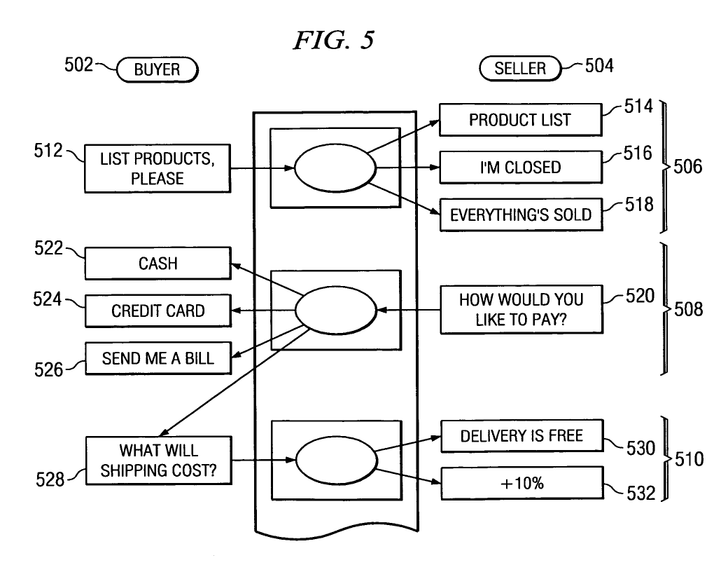

The film-strip view was designed with the intent of easing the design of new conversation policies and is shown with reference to FIG. 5. The basic idea is that by decomposing a conversation into a series of simple statements (or questions) and their expected responses, a conversation will be more easily comprehended by its designers. In this figure, the conversation is between two parties, which are labeled buyer 502 and seller 504. A question or answer that is given by buyer 502 is always listed on the left-hand side of this diagram, while a question or answer that is given by seller 504 is always listed on the right-hand side to the diagram. This helps to keep it immediately clear who is performing each step. In this exemplary view, three separate but related interactions take place. In interaction 506, buyer 502 requests a list of products 512. According to the diagram, the designer has come up with three responses: the seller supplies a product list 514, the seller tells the buyer that the store is closed 516, or the sellers notes that everything has already been sold 518. While these hypothetical responses are rather tongue-in-cheek, they illustrate that seller 504 does have a range of responses. In interaction 508, the seller asks how the buyer would like to pay 520. Responses include cash 522, credit card 524, and a request to be billed 526. This diagram also shows that the buyer may respond with a question in return about charges for shipping 528. The same question regarding shipping 528 may also be asked as a separate question as part of interaction 510, with possible seller responses shown by a ‘delivery is free’ message 530 and a ‘+10%’ message 532. The final two entries 536, 538 will be discussed below.

The creation of a filmstrip format will now be discussed with reference to FIG. 6B. When the program starts, it first formats a template having a place for each of the two respondents, such as the buyer 502 and seller 504 of FIG. 5. It can have an image of a ‘filmstrip’ 540 having multiple ‘frames’ 542 as shown in the previous diagram, although these are suggestive only and are not required. The other required entries are empty blanks for questions and answers 536, 538. Since who will be asking the next question is not automatically known, the direction of flow in this frame 540 cannot be determined at this time, but will be added later. The user is then prompted for the names of the respondents in this policy, then stores them in the spaces provided in the template (step 652). The user is then prompted to provide a question for the policy and the name of which respondent is asking the question (step 654). When the question is received, it will be stored in the entry under the proper respondent (step 656). For example, if the seller of FIG. 5 is asking the next question, the text of the question would be stored in entry 538; if the buyer were asking, the text would be stored in entry 536. The program can also mark the direction of information flow once the questioner is known, so that the questioner sends questions ‘to’ the filmstrip while the answers come ‘out of’ the filmstrip. The program next prompts the user to supply a possible answer to the question (step 658). The program will keep track of which side the question was stored on and will store the answer on the opposite side (step 660). The user is then asked if there are additional answers to the current question (step 662). If so, a new entry for an answer will be created on the correct side of the diagram (step 664) and the program returns to step 658 to continue processing. If not, the program must next ask if additional questions exist for the policy (step 666). If there are more questions, another ‘frame’ is added to the template (step 668) and the program returns to step 654 to continue processing. If no additional questions remain, the program can write the filled template to either storage or to a printer (step 670) and terminate.

The order of each of the filmstrip “cells” may be rearranged or scrolled at will, since at this point, the order has no semantic meaning. This aligns with the behavior of natural language conversations. For example, a buyer may enter a store and immediately begin discussing shipping options before selecting a product or a payment method, or he may engage in a more “conventional” pattern. The designer of the conversation is not asked to specify the literal order of every message, but a series of messages and their responses. This does not imply that a specific order will not be imposed at a later point, merely that the designer does not have to be concerned at this point. A policy generation tool would automatically assemble the actual program representing the conversation, such as the XML file shown above.

Once a designer has come up with the questions that may occur during a given transaction, this construction can be turned over to a policy-generation tool, such as the program disclosed in co-pending application (Atty. Docket AUS920040543).

Conversion Between Formats

While it has been disclosed that the tabular form is primarily used for completed conversations and the filmstrip version is primarily used for creating conversation policies, there are situations where it can be desirable to convert from any of the three formats, XML file, filmstrip format, or tabular format, into another of the formats. For example, when adding a step to an existing conversation policy, a person may find it helpful to convert the extensible markup language format of the conversation into a filmstrip format to visualize questions that are already being asked and the best place to add a new step. Although the discussion above mentions that the order of the filmstrip does not necessarily follow the order of the policy, the format is inherently linear and so is able to present the information in a sequential order. This can be useful in making changes, especially for someone who is new to writing conversation policies. Likewise, after examining a number of conversations executed under a policy, the user may wish to make modifications to the tabular format, then convert the tabular format back to an extensible markup language format. The following flowcharts show how this can be done.

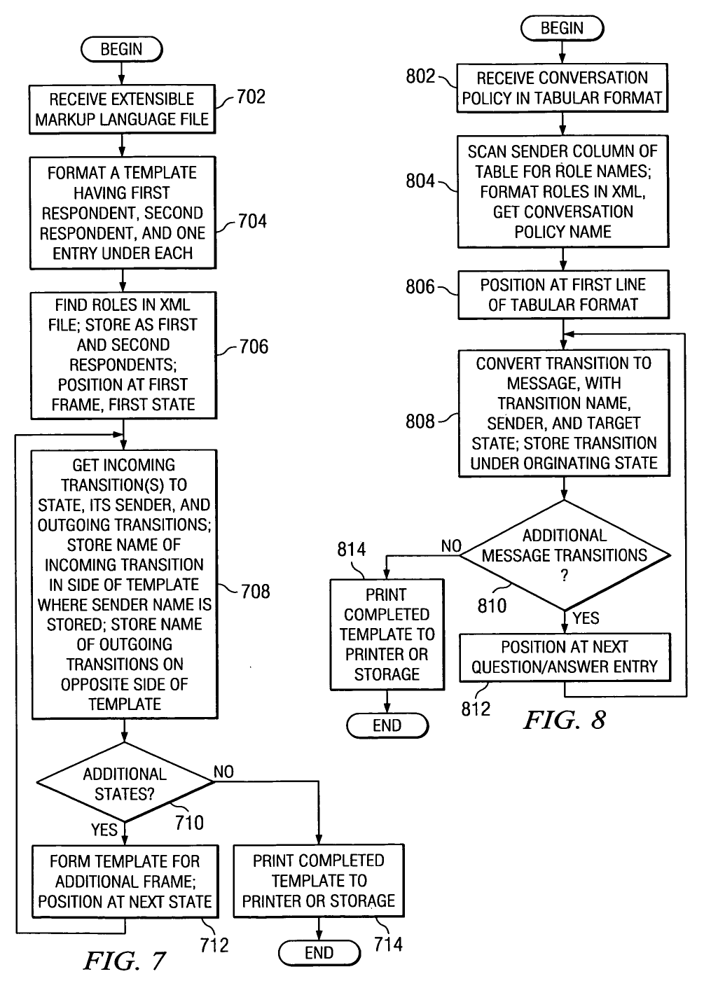

When converting between an XML file and the filmstrip format, it can be helpful to think of each frame of the strip as a state, with the response (question) from one entity having one or more possible responses from the other entity. FIG. 7 depicts a flowchart for converting an extensible markup language format to a filmstrip format. The program first receives a file in some form of extensible markup language (step 702). A template for the filmstrip can be setup as in the prior example, with a first and second respondent and a frame created for a first interaction (step 704). The roles defined in the XML file are located and stored in respective positions as the first and second respondent (step 706). The various states can then be identified; although neither the initial state (e.g., Ready state 310) nor the terminal states (e.g, Deal made state 318, No deal 320) are a trigger/response, so these can be ignored; other states have both incoming and outgoing transitions. For each state, the transition or transitions that take the conversation into the state can be stored under the respondent who sends the message, while the possible responses are stored under the opposite respondent. For example, in FIG. 3, for the Is available state 314, the incoming transition is a message that a product is available while the outgoing transitions are timeout 324, load haggle 328, and bye 332. These transitions can be stored as labeled, with user input allowed to make them more understandable, e.g., the user can replace the incoming transition with the response “We have the product; what do you want to do?” and replace the outgoing transitions with “no response”, “let's talk”, and “nothing” respectively. After the state is formatted into a response/response, the program looks to see if there are additional states (step 710). If there are, the program creates a template for another response and moves to the next state (step 712) and then returns to step 708 to process the state. Otherwise, the process can print or store the completed filmstrip (step 714) and terminates.

FIG. 8 demonstrates an exemplary flowchart for converting a tabular format to an XML file. In order to perform this conversion, it is necessary to know the states associated with each message sent, i.e., the state from which the message is sent and the state that it moves the conversation to. This information would be present if the tabular format were originally converted from an XML format or can be retrieved from the program managing the conversation, if the tabular format is of an actual conversation. The program receives a file containing a conversation policy or actual conversation in tabular format (step 802). The table column that contains the senders can be scanned to determine the roles that are used in this conversation and the roles defined in the XML file and additional information, such as name of conversation policy can be picked up from the stored information (step 804). Next the program positions at the first line of the tabular format (step 806). Each line in the table format represents a transition between two states; the information regarding the transition becomes a message in the XML file, listed under the state from which it originates and indicating the state to which it moves the conversation (step 808); this conversion is thus fairly straightforward. After a transition is converted, the program looks to see if there are additional messages (step 810). If there are, the program increments to the next message (step 812) and return to step 808 for conversion; otherwise the program will save or print the completed XML file (step 814) and terminates.

New formats for displaying conversations and conversation policies have now been shown, as well as the means to convert between the various formats. In any conversion, the principal elements of a conversation or conversational policy—states, transitions, and roles (respondents) must be identified. These elements can then be converted from one format to another as desired by the user. In at least one embodiment, a file can be input into a conversion program in any of the three formats shown—an extensible markup language format, a filmstrip format, or a tabular format—and an output file requested in any of the remaining formats. Using these formats, the study and creation of conversation policies will become more easily studied and managed.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of designing a conversation policy, said method comprising the computer-executed steps of:
formatting a template for a conversation, said template having a first respondent, a second respondent, and a plurality of question/answer entries, each of said question/answer entries containing a respective entry for a question, for a questioner, and for a plurality of answers;
receiving, from a user, a name for said first respondent and a name for said second respondent, wherein said designation for said first respondent is placed on a first side of said template and said designation for said second respondent is placed on an opposite side of said template;
prompting the user to provide, for a question that should be resolved in said conversation policy, a question text, a designation of whether said first respondent or said second respondent would ask the question, and a plurality of answer texts for said question; and
in a respective question/answer entry, storing said question text on a side of said template corresponding to said designation and storing each of said plurality of answer texts in a respective entry for answer on an opposite side of said template; and
writing said template.

2. The method of claim 1, wherein said prompting step and said storing step are performed repetitively.

3. The method of claim 1, wherein said writing step writes to a screen.

4. The method of claim 1, wherein said writing step writes to a printer.

5. The method of claim 1, wherein instructions for performing said method are stored on a computer readable media.

6. A method of analyzing a conversation policy, said method comprising the computer-executed steps of:
formatting a table having columns corresponding to a unique identification, a time a message was sent, a message name, and a message argument;
receiving a plurality of messages sent during a conversation executed according to said conversation policy;
for each of said plurality of messages, creating a row in said table and using said message to provide values in corresponding columns of said row; and
writing said table to a device.

7. The method of claim 6, wherein said formatting step further formats additional columns corresponding to at least one of (a) an identification number of one of said plurality of messages that the current message is in response to, (b) a designation of whether or not the current message is within the context of said conversation policy, (c) a time delay between the time the current message was sent and the time the previous message was sent, and (d) an emotion associated with the current message.

8. The method of claim 7, wherein the user inserts values for each of said additional columns.

9. The method of claim 7, wherein an automated program provides values for each of said additional columns.

10. The method of claim 6, wherein said writing step writes to a screen.

11. The method of claim 6, wherein said writing step writes to a printer.

12. The method of claim 6, wherein instructions for performing said method are stored on a computer readable media.

13. A method of converting a conversation policy to a different format, said method comprising the computer-executed steps of:
receiving a file in a first format chosen from the group consisting of tabular format, filmstrip format, and extensible markup language format;
identifying, in said file, respondent roles, states, and transitions between states; and
formatting said file into a second format, different from said first format, chosen from said group.

14. The method of claim 13, wherein instructions for performing said method are stored on a computer readable media.

15. The method of claim 13, wherein said first format is a tabular format and said second format is an extensible markup language format.

16. The method of claim 13, wherein said first format is a tabular format and said second format is a filmstrip format.

17. The method of claim 13, wherein said first format is a filmstrip format and said second format is a tabular format.

18. The method of claim 13, wherein said first format is a filmstrip format and said second format is an extensible markup language format.

19. The method of claim 13, wherein said first format is an extensible markup language format and said second format is a filmstrip format.

20. The method of claim 13, wherein said first format is an extensible markup language format and said second format is a filmstrip format.
